(19) United States
(12) Patent Application Publication
(10) Pub. No.: US 2020/0006759 A1
(43) Pub. Date: Jan. 2, 2020

(54) CORE-SHELL-COMPOSITE PARTICLES FOR ANODE MATERIALS OF LITHIUM-ION BATTERIES

(71) Applicant: WACKER CHEMIE AG, München (DE)

(72) Inventors: Sefer Ay, München (DE); Robert Maurer, München (DE); Jürgen Stohrer, Pullach (DE); Jennifer Wegener, München (DE)

(21) Appl. No.: 16/484,891

(22) PCT Filed: Feb. 10, 2017
(86) PCT No.: PCT/EP2017/053075

§ 371 Date: Aug. 9, 2019

(51) Int. Cl. H01M 4/36; H01M 4/38; H01M 4/587; H01M 10/0525

(52) U.S. Cl. CPC H01M 4/366; H01M 4/364; H01M 2004/021; H01M 4/587; H01M 10/0525; H01M 4/386

(57) ABSTRACT

The invention relates to core-shell composite particles, wherein the shell is based on carbon and is nonporous and the core is a porous aggregate containing a plurality of silicon particles, carbon and optionally further components, where the silicon particles have average particle sizes (d₅₀) of from 0.5 to 5 μm and are present in the core in a proportion of ≥80% by weight, based on the total weight of the core-shell composite particles.

The invention relates to core-shell composite particles, wherein the core contains silicon particles and carbon and the shell is based on carbon, and also processes for producing the core-shell composite particles and their use in anode materials for lithium ion batteries.

Rechargeable lithium ion batteries are at present the commercially available electrochemical energy stores having the highest specific energy of up to 250 Wh/kg. They are used especially in the field of portable electronics, for tools and also for transport means, for example bicycles or automobiles. However, particularly for use in automobiles, it is necessary to achieve a further significant increase in the energy density of the batteries in order to obtain longer ranges of the vehicles.

In present-day practice, graphitic carbon is mainly used as negative electrode material (“anode”). Graphitic carbon displays stable cycling properties. Thus, graphitic carbon experiences only small volume changes on incorporation and release of lithium, for example in the region of 10% for the limiting stoichiometry of LiC₆. However, a disadvantage is its relatively low electrochemical capacity of theoretically 372 mAh/g, which corresponds to only about one tenth of the electrochemical capacity which can be theoretically achieved using lithium metal.

In contrast, silicon has the highest known storage capacity for lithium ions, namely 4199 mAh/g. Disadvantageously, silicon-containing electrode active materials suffer extreme volume changes of up to about 300% on loading or unloading with lithium. This volume change results in severe mechanical stresses of the active material and the entire electrode structure, which as a result of electrochemical milling leads to loss of electrical contacting and thus to destruction of the electrode, with a loss of capacity. Furthermore, the surface of the silicon anode material used reacts with constituents of the electrolyte with continuous formation of passivating protective layers (solid electrolyte interface; SEI), which leads to an irreversible loss of mobile lithium.

To improve the cycling stability of lithium ion batteries, L. Chen in Materials Science and Engineering B, 131, 2006, pages 186 to 190, recommends the use of carbon-coated silicon/graphite/carbon composite particles (Si/G/C) as anode active material. To produce these, dispersions of silicon particles (particle sizes <100 nm), graphite and phenol-formaldehyde resin were spray dried and the products of spray drying were carbonized at 1000° C. to form Si/G/C composite particles which were coated with carbon by coating with a phenol-formaldehyde resin and subsequent carbonization. The particles obtained had diameters of about 40 μm. Z. Shao, Journal of Power Sources, 248, 2014, pages 721 to 728, also describes carbon-coated Si/G/C composites, with the silicon particles having particle diameters of from 30 to 50 nm.

Y. Cui, ACS NANO, 2015, vol. 9, no. 3, pages 2540 to 2547, discloses porous Si/C composite particles having a porous carbon-free core composed of aggregated nanosized silicon primary particles and a carbon coating as shell. The nanosized silicon primary particles have diameters of less than 10 nm. The aggregated nanosized silicon primary particles were produced by thermal disproportionation, of silicon suboxides SiOₓ. The carbon coating was based on a carbonized resorcinol-formaldehyde resin. After production of the carbon coating, silicon dioxide was leached from the core by means of hydrogen fluoride solution. Such Si/C composite particles are also described in WO2015051309, with the nanosized silicon primary particles here being able to have diameters of less than 200 nm. In addition, WO2015051309 discloses, as an alternative embodiment, porous, carbon-based composite particles in the pores of which nonporous silicon particles are incorporated. U.S. Pat. No. 9,209,456 discusses a variety of variants of core-shell composite particles having a porous core. The shell can be, inter alia, a carbon coating, and the porous core can be, for example, porous silicon particles. For the production of porous silicon particles, U.S. Pat. No. 9,209,456 mentions the reduction of silica, the corrosion of Si structures, ultrasonic treatment during crystallization of silicon melts, or the introduction of reactive materials such as hydrogen or bromine into silicon melts and subsequent etching-out of pores. The particles can also be present in needle or rod shapes. Relatively large silicon particles having diameters of a few hundred nanometers are described as unsuitable in U.S. Pat. No. 9,209,456.

CN104362311 teaches Si/C composites which contain nanosized silicon particles having diameters of less than 150 nm. US20110165468, too, discloses Si/C composites produced by spray drying of dispersions containing Si particles and oxygen-free polymers followed by pyrolysis of the polymers. The Si/C composites do not bear a further carbon shell. KR20150128432 describes porous, carbon-coated Si/C composites. They are produced by firstly spray drying suspensions containing Si particles, conductive additives (graphene, graphite or CNT (carbon nanotubes)), pore formers (water-soluble salts) and polymeric carbon precursors and subjecting the products of drying to carbonization. The carbonization products were subsequently wet-chemically coated with further carbon precursors and carbonized again. The pore formers were leached from the resulting products by means of water, which inevitably gives carbon coatings which are not impermeable. In addition, the product particles display significant aggregation. The porous Si/C composites of KR20150128430 were also produced by spray drying of suspensions containing Si particles, conductive additives, pore formers and carbon precursors and subsequent carbonization. The water-soluble pore formers were leached from the composite. The Si/C composites of KR20150128430 do not bear an enveloping carbon coating.

In the light of this background, it was an object of the invention to provide composite particles which contain silicon particles and when used in lithium ion batteries make a high cycling stability possible, in particular lead to very low SEI formation and/or reduce electrochemical milling. In addition, the silicon-containing composite particles should if possible have a high mechanical stability and not be very brittle.

The invention provides core-shell composite particles, wherein the shell is based on carbon and is nonporous and the core is a porous aggregate containing a plurality of silicon particles, carbon and optionally further components, where the silicon particles have average particle sizes (d₅₀) of from 0.5 to 5 μm and are present in the core in a proportion of ≥80% by weight, based on the total weight of the core-shell composite particles.

The invention further provides processes for producing the core-shell composite particles of the invention, wherein
1) dispersions containing silicon particles having average particle sizes (d₅₀) of from 0.5 to 5 μm, one or more organic binders, one or more dispersion media and optionally one or more additives are dried,
2) the products of drying from step 1) are optionally thermally treated and
3) one or more carbon precursors are carbonized on the products of drying from step 1) or on the thermally treated products of drying from step 2).

The invention further provides core-shell composite particles obtainable by the processes of the invention. The core of the core-shell composite particles is essentially an aggregate of a plurality of silicon particles. The individual silicon particles are preferably nonporous and/or preferably unaggregated. Without wishing to be tied to a theory, the aggregation of the individual silicon particles can be brought about by means of the carbon introduced according to the invention into the core.

The volume-weighted particle, size distribution of the silicon particles has diameter percentiles d₅₀ of preferably from 600 nm to 4.5 μm, more preferably from 700 nm to 4.0 μm, particularly preferably from 750 nm to 3.0 μm and most preferably from 750 nm to 2.0 μm.

The determination of the volume-weighted particle size distribution is generally, unless indicated otherwise in the individual case, carried out by static laser light scattering using the Mie model and the, measuring instrument Horiba LA 950 and using alcohols, for example ethanol or isopropanol, or is preferably water as dispersion medium.

The silicon particles used for producing the core-shell composite particles are preferably not agglomerated, particularly preferably not aggregated, most preferably not porous. The silicon particles used are thus preferably present in solid form. Aggregated means that spherical or largely spherical primary particles, as are initially formed, for example, in gas-phase processes in the production of the silicon particles, have grown together to form aggregates. Aggregation of primary particles can, for example, occur during production of the silicon particles in gas-phase processes. Such aggregates can form agglomerates during the further course of the reaction. Agglomeratea are a loose assembly of aggregates. Agglomerates can easily be broken up into the aggregates again by means of kneading and dispersing methods which are typically used. Aggregates cannot be broken up, or can be broken up to only a small extent, into the primary particles by means of these methods. One to the way in which they are formed, aggregates and agglomerates inevitably have quite different sphericities, particle shapes and porosities than the silicon particles which are preferably used. The presence of silicon particles in the form of aggregates or agglomeratea can, for example, be made visible by means of conventional scanning electromicroscopy (SEM). On the other hand, static light scattering methods for determining the particle size distributions or particle diameters of silicon particles cannot distinguish between aggregates or agglomerates.

The BET surface areas of the silicon particles are preferably from 0.1 to 30.0 m²/g, particularly preferably from 0.5 to 20.0 m²/g and most preferably from 1.0 to 16.0 m²/g. The BET surface area is determined in accordance with DIN 66131 (using nitrogen).

The pores of the silicon particles are preferably <2 nm (method of determination: pore size distribution by the BJH method (gas adsorption) in accordance with DIN 66134).

The silicon particles are preferably present in splinter-like particle shapes. The silicon particles have a sphericity of preferably 0.3≤ψ≤1, particularly preferably 0.7≤ψ0.99 and most preferably 0.8≤ψ≤0.98. The sphericity is the ratio of the surface area of a sphere of the same volume to the actual surface area of a body (definition of Wadell), Sphericities can be determined, for example, from conventional scanning electron micrographs.

According to an alternative definition, the sphericity S is the ratio of the diameter equivalent to a circle of the projected area A of a particle onto a plane to the corresponding diameter from the circumference U of this projection: S=2\sqrt{πA}/U. In the case of an ideal circle, S has the value 1. For the silicon particles of the invention, the sphericity S is in the range of preferably from 0.3 to 1, particularly preferably from 0.7 to 0.99 and most preferably from 0.8 to 0.98. The sphericity S is measured by graphical evaluation of images of individual particles taken using an optical microscope or in the case of particles <10 μm using a scanning electron microscope.

The silicon particles are preferably based on elemental silicon. For the purposes of the present invention, elemental silicon is high-purity, polycrystalline silicon having a small proportion of foreign atoms (for example B, P, As), silicon deliberately doped with foreign atoms (for example F, P, As) or else silicon from metallurgical processing, which can have elemental contamination (for example Fe, Al, Ca, Cu, Zr, Sn, Co, Ni, Cr, Ti, C).

If the silicon particles contain a silicon oxide, the stoichiometry of the oxide SOₓ is then preferably in the range 0<x<1.3. If the silicon particles contain a silicon oxide having a higher stoichiometry, then the layer thickness of this on the surface is preferably less than 10 nm.

When the silicon particles are alloyed with an alkaline metal M, the stoichiometry of the alloy M_{y}Si is then preferably in the range 0<y<5. The silicon particles can optionally be prelithiated. If the silicon particles are alloyed with lithium, the stoichiometry of the alloy Li_{z}Si is preferably in the range, 0<z<2.2.

Particular preference is given to silicon particles which contain ≥80 mol % of silicon and/or ≤20 mol % of foreign atoms, very particularly preferably ≤10 mol % of foreign atoms.

The silicon particles can, for example, be produced by means of vapor deposition, by atomization processes, by plasma rounding or preferably by milling processes. In the case of atomization processes, the silicon is melted, converted into droplets and then cooled with solidification, giving silicon in particulate form. The conventional water atomization or gas atomization processes are suitable for this purpose. Possible milling processes are, for example, dry or wet milling processes. Planetary ball mills, jet mills such as opposed jet or impingement mills or stirred ball mills are preferably used here. Wet milling is generally carried out in a suspension comprising inorganic or organic dispersion media, for example alcohols, aliphatics or water.

The dispersions in step 1) preferably contain ≥70% by weight, particularly preferably from 80 to 99% by weight and most preferably from 90 to 99% by weight, of silicon particles, based on the dry weight of the dispersions in step 1).

The organic binders are preferably polymers. The organic binders preferably contain one or more functional groups selected from the group consisting of carboxyl, hydroxy, amide, ether and trialkozysilyl groups, Carboxyl groups are most preferred.

The organic binders are preferably soluble in solvents, in particular in alcohols such as methanol or ethanol and/or water. Soluble means that the organic binders are soluble to an extent of preferably ≥2% by weight in the solvent under standard conditions (23/50) in accordance with DIN50014.

Preferred organic binders are resorcinol-formaldehyde resin; phenol-formaldehyde resin; lignin; carbohydrates such as polysaccharides, cellulose or cellulose derivates; polyamides; polyimides, in particular polyamideimides; polyethers, polyvinyl alcohols; homopolymers and copolymers of vinyl esters, in particular polyvinyl acetate and vinyl acetate-ethylene copolymers; homopolymers and copolymers of (meth)acrylic acid, in particular poly(meth)acrylic acid and styrene-(meth)acrylic acid copolymers; polyarylonitriles and polyvinylpyrrolidones.

Preference is also given to salts of polymers bearing carboxylic acid groups. Preferred salts are alkali metal salts, in particular lithium, sodium or potassium salts.

Particularly preferred organic binders are carboxymethyl cellulose, or salts thereof, polyacrylic acid or salts thereof, polymethacrylic acid or salts thereof and polyvinyl acetate.

The dispersions in step 1) preferably contain from 1 to 30% by weight, particularly preferably from 1 to 20% by weight and most preferably from 1 to 10% by weight, of organic binders, based on the dry weight of the dispersions in step 1).

As dispersion media in step 1), it is possible to use organic and/or inorganic solvents. Mixtures of two or more dispersion media can also be used.

An example of an inorganic solvent is water.

Organic solvents are, for example, hydrocarbons, esters or preferably alcohols. The alcohols preferably contain from 1 to 7 and particularly preferably from 2 to 5 carbon atoms. Examples of alcohols are methanol, ethanol, propanol, butanol and benzyl alcohol. Hydrocarbons preferably contain from 5 to 10 and particularly preferably from 6 to 8 carbon atoms. Hydrocarbons can, for example, be aliphatic or aromatic. Examples of hydrocarbons are toluene and heptane. Esters are generally esters of carboxyiic acids and alkyl alcohols, for example ethyl acetate.

Preferred solvents are water and alcohols, in particular ethanol and 2-propanol.

The dispersions in step 1) preferably contain from 50 to 95% by weight, particularly preferably from 60 to 90% by weight and most preferably from 70 to 80% by weight, of dispersion medium, based on the total weight of the dispersions in step 1).

Examples of additives in step 1) are electrically conductive components, pore formers, acids, fluidizers, surfactants or dopants.

Examples of electrically conductive components are graphite particles, conductive carbon black, carbon nanotubes or metallic particles, for example, copper particles. The dispersions in step 1) preferably contain from 0 to 5% by weight of electrically conductive components, based on the dry weight of the dispersions in step 1). The core-shell composite particles preferably do not contain any electrically conductive components, in particular do not contain any graphite.

The pore formers can be inorganic or preferably organic in nature. Examples of inorganic pore formers are silicon dioxide, magnesium oxide, sodium chloride and magnesium carbonate. Examples of organic pore formers are polymers of ethylenically unsaturated monomers, melamine resins and urea resins. Preferred organic pore formers are selected from the group consisting of polyethylene, polystyrene, polymethyl methacrylate, polyvinyl acetate-ethylene-acrylate terpolymer, styrene-butadiene copolymer and melamine-formaldehyde resins.

The dispersions in step 1) preferably contain from 0 to 40% by weight, particularly preferably from. 5 to 30% by weight and most preferably from 10 to 20% by weight, of pore formers, based on the dry weight of the dispersions in step 1). As an alternative, pore formers can be omitted.

The acids can be inorganic or preferably organic in nature. Examples of organic acids are aromatic or aliphatic sulfonic acids, e.g. para-toluenesulfonic acid; monofunctional or polyfunctional aliphatic carboxylic acids, e.g. formic acid, acetic acid, ascorbic acid, citric acid, trifluoroacetic acid and fatty acids such as stearic acid; aromatic carboxylic acids such as terephthalic acid and benzoic acid; and amino acids such as glycine. Examples of inorganic acids are, sulfuric acid, phosphoric acid, hydrochloric acid and nitric acid. The dispersions in step 1) preferably contain 5% by weight, particularly preferably ≤2% b weight, of organic acids. The dispersions in step 1) preferably contain ≤1% by weight, particularly preferably ≤0.5% by weight, of inorganic acids.

The figures in % by weight are in each case based on the dry weight of the dispersions in step 1).

The dispersions in step 1) preferably contain from 0 to 40% by weight, particularly preferably from 0.01 to 20% by weight and most preferably from 0.1 to 5% by weight, of additives, based on the dry weight of the dispersions in step 1). In a preferred, alternative embodiment, no additives are used in step 1.

The dispersions in step 1) have a solids content of preferably from 5 to 40%, particularly preferably from 10 to 30% and most preferably from. 15 to 25%. The dispersions in step 1) have a pH of preferably ≤7.5, particularly preferably from 1 to 7. The dispersions used for drying in step 1) are preferably present in a fluid state.

The production of the dispersions in step 1) can be carried out by mixing of their individual constituents and is not tied to any particular procedure. The silicon particles are preferably used in the form of dispersions, in particular alcoholic dispersions, or as solid. The organic binders and/or pore formers can be used in solid form or preferably in the form of solutions or dispersions, in particular in the form of aqueous solutions or aqueous dispersions. Mixing can be carried out in conventional mixing apparatuses, for example in rotor-stator machines, high-energy mills, planetary kneaders, stirred ball mills, shaking tables, high-speed mixers, roll mills or ultrasonic instruments.

The drying in step 1) can, for example, be carried out by means of fluidized-bed drying, thermal drying, drying under reduced pressure, contact drying, convection drying or by means of spray drying. Preference is given to spray drying. The conditions and plants customary for this purpose, for example spray driers, fluidized-bed driers or paddle driers, can be employed. Preference is given to spray driers and fluidized bed driers.

Drying can be carried out in ambient air, synthetic air or preferably in an inert gas atmosphere, for example in a nitrogen or argon atmosphere. In general, drying is carried out at atmospheric pressure or in particular under reduced pressure, for example from 1 to 10⁻³ mbar, in particular from 100 to 10⁻³ mbar. Drying is generally carried out at temperatures of preferably ≤200° C. and particularly preferably ≤150° C.

Drying under reduced pressure is preferably carried out from 40° C. to 100° C. and from 1 to 10⁻³ mbar, in particular from 100 to 10⁻³ mbar.

Spray drying can, for example, be carried out in spray drying plants in which atomization is carried out by means of one-fluid, two-fluid or multifluid nozzles or by means of a rotating disk. The inlet temperature of the dispersion to be dried into the spray drying plant is preferably greater than or equal to the boiling point of the dispersion to be dried and particularly preferably ≥10° C. higher than the boiling point of the dispersion to be dried. For example, the inlet temperature is preferably from 80° C. to 200° C., particularly preferably from 100° C. to 150° C. The outlet temperature is preferably ≥30° C., particularly preferably ≥40° C. and most preferably ≥50° C. In general, the outlet temperature is in the range from 30° C. to 100° C., preferably from 45° C. to 90° C. The pressure in the spray drying plant is preferably ambient pressure. In the spray drying plant, the sprayed dispersions have primary droplet sizes of preferably from 1 to 1000 μm, particularly preferably from 2 to 600 μm and most preferably from 5 to 300 μm. The size of the primary particles, residual moisture content of the product and the yield of product can be set in a manner known per se by setting of the inlet temperature, the gas flow and the pumping rate (feed rate), the selection of the nozzle, of the aspirator, the selection of dispersion media or the solids concentration of the dispersion being sprayed. For example, particles having larger particle sizes are obtained at higher solids concentration of the dispersion being sprayed, while a higher spraying gas flow leads to smaller particle sizes.

The products obtained after drying in step 1) preferably contain ≤10% by weight, more, preferably ≤5% by weight, even more preferably ≤3% by weight and most preferably ≤1% by weight, of dispersion medium, based on the total weight of the products of drying from step 1).

The products of drying from step 1) are preferably present in the form of particles, in particular in the form of agglomerates. Agglomerates can easily be broken up again into the starting materials by means of kneading or dispersing processes. Agglomerates can be loose assemblies of their individual constituents. The products of drying are preferably redispersible, especially in water. During redispersing, the products of drying from step 1) generally disintegrate again into their initial constituehts, in particular into silicon particles and organic binders.

The products of drying from step 1) have diameter percentiles d₅₀ of preferably from 1 to 30 μm, particularly preferably from 2 to 20 μm (method of determination: SEM).

The products of drying from step 1) have a sphericity of preferably 0.3≤ψ≤1.0, particularly preferably 0.7≤ψ≤0.99 and most preferably 0.8≤ψ≤0.98.

The porosity of the products of drying from step 1) is preferably from 30 to 75% and particularly preferably from 35 to 70% (method of determination: Hg porosimetry or preferably in combination with He pycnometry in accordance with DIN 66137-2).

The term porosity generally refers to the particulate porosity, i.e. the volume of the pores within the respective particles. The hollow space volume, which is located between the particles, i.e. in the interstices between the, particles, is different therefrom. The particulate porosity thus generally relates to the pore volume which is present within the particles from step 1), within the core of the particles according to the invention or within the core-shell particles. The porosity according to the invention can frequently be determined, for example, by means of Hg porosimetry or xylene or He pycnometry.

The thermal treatment in step 2) is carried out at temperatures of preferably from 200 to 500° C., particularly preferably from 220 to 400° C. Step 2) can be carried out under any pressures. A pressure of from 0.5 to 2 bar, in particular from 0.8 to 1.5 bar, is preferably employed. The thermal treatment is particularly preferably carried out at ambient pressure.

In the thermal treatment, it is possible for, for example, a decomposition of the organic binders, for example an elimination of carbon dioxide, carbon monoxide or water, or a carbonization of the organic binders to occur or a reaction with the silicon particles to take place.

The thermal treatment can be carried out in ambient air, synthetic air or in an inert gas atmosphere, for example in a nitrogen or argon atmosphere.

The duration of the thermal treatment can be, for example, from 1 to 10 hours, preferably from 2 to 8 hours and particularly preferably from 3 to 6 hours.

The thermal treatment can be carried out in conventional reactors, for example in a calcination furnace, tube furnace, in particular a rotary tube furnace, fluidized-bed reactor, moving-bed reactor or a drying oven. Particular preference is given to calcination furnaces, fluidized-bed reactors and rotary tube furnaces.

The products of the thermal treatment from step 2) are preferably present in the form of particles, in particular in the form of aggregates. Aggregates generally cannot be broken up into their starting materials by means of conventional kneading or dispersing processes. The products of the thermal treatment are preferably not redispersible, in particular not in water.

The products from step 2) have diameter percentiles d₅₀ of preferably from 1 to 30 μm, particularly preferably from 2 to 20 μm.

The porosity of the products from step 2) or the porosity of the core of the core-shell composite particles is preferably from 30 to 75% and particularly preferably from 40 to 65% (method of determination: Hg porosimetry or preferably He pycnometry in accordance with DIN 66137-2).

The products from step 2) have a sphericity of preferably 0.≤ψ≤1.0, particularly preferably 0.7≤ψ≤0.98 and most preferably 0.8≤ψ≤0.95.

The products from step 2) preferably contain ≥90% by weight, particularly preferably ≥92% by weight, even more preferably ≥94% by weight and most preferably ≥98% by weight, of silicon particles. The silicon particles are preferably present in an amount of ≤99.9% by weight, particularly preferably ≤99% by weight and most preferably ≤95% by weight. The figures in % by weight are based on the total weight of the products from step 2).

Carbon is preferably present in an amount of from 0.01 to 10% by weight, particularly preferably from 0.02 to 7% by weight and most preferably from 0.02 to 5% by weight, based on the total weight of the products from step 2).

The shell of the core-shell composite particles is based on carbon, in particular amorphous carbon. The shell is nonporous. The carbonization of the carbon precursors according to the invention inevitably leads to a nonporous shell. The shell preferably surrounds the core of the core-shell composite particles at least partly and particularly preferably completely.

The pores of the shell are preferably <10 nm, particularly preferably ≤5 nm and most preferably ≤2 nm (method of determination: pore size distribution by the BJH method. (gas adsorption) in accordance with DIN 66134).

The shell preferably has a porosity of ≤2% and particularly preferably ≤1% (method of determination: BJH measurement).

The shell is generally impermeable to liquid media, in particular aqueous or organic solvents or solutions. The shell is particularly preferably impermeable to aqueous or organic electrolytes. The impermeability to liquids of the core-shell composite particles is preferably ≥95%, particularyly preferably ≥96% and most preferably ≥97%. The impermeability to liquids can, for example, be determined by a method corresponding to the method of determination “Impermeability test” indicated below for the examples.

The proportion of the shell is preferably from 1 to 10% by weight, particularly preferably from 3 to 7% by weight and most preferably from 2 to 8% by welght, based on the. total weight of the core-shell composite particles.

The shell of the core-shell composite particles is obtainable by carbonization of one or more carbon precursors, for example tars or pitches, in particular high-melting pitches, polyacrylonitrile or hydrocarbons having from 1 to 20 carbon atoms. As pitch, preference, is given to mesogenic pitch, mesophase pitch, petroleum pitch or hard coal tar pitch. Examples of hydrocarbons are aliphatic hydrocarbons having from 1 to 10 carbon atoms, in particular from 1 to 6 carbon atoms, preferably methane, ethane, propane, propylene, butane, butene, pentane, isobutane, hexane.; unsaturated hydrocarbons having from 1 to 4 carbon atoms, e.g. ethylene, acetylene or propylene; aromatic hydrocarbons such as benzene, toluene, styrene, ethylbenzene, diphenylmethane or naphthalene; further aromatic hydrocarbons such as phenol, cresol, nitrobenzene, chlorobenzene, pyridine, anthracene, phenanthrene.

Preferred carbon precursors for the shell are, mesogenic pitch, mesophase pitch, petroleum pitch, hard coal tar pitch, methane, ethane, ethylene, acetylene, benzene, toluene. Particular preference is given to acetylene, toluene and in particular ethylene, benzene and soft carbon from petroleum pitch or hard coal tar pitch.

In step 3) of the process of the invention, one or more carbon precursors are carbonized on the products of drying from step 1) or on the thermally treated products of drying from step 2) or on the core of the core-shell composite particles of the invention.

Hydrocarbons having from 1 to 20 carbon atoms are preferably applied by the CVD process. The CVD process can be carried out in a conventional way.

The other carbon precursors for the shell are preferably applied by coating to the products of step 1) and/or step 2) and subsequently thermally carbonized. Coating can, for example, be carried out by inducing dispersions containing carbon precursors and products of step 1) and/or step 2) to precipitate. Here, carbon precursors can precipitate on the products of step 1) and/or step 2). The coated products can be isolated by subsequent filtration, centrifugation and/or drying. Carbonization can be carried out thermally, for example at temperatures of from 400 to 1400° C., preferably from 500 to 1100° C. and particularly preferably from 700 to 1000° C. The conventional reactors and other customary reaction conditions can be employed for this purpose.

Any organic binders from step 1) or their downstream products from step 2) which are present can also be carbonized in step 3). Organic binders are generally no longer present after the carbonization in step 3).

Undersized or oversized particles can optionally be removed in a subsequent step A), for example by means of typical classification techniques such as sieving or sifting.

The individual core-shell composite particles can, for example, be present as isolated particles or as loose agglomerates. The core-shell composite particles can occur in the form of splinters or flakes or preferably in spherical form.

The volume-weighted particle size distribution with diameter percentiles d₅₀ of the core-shell composite particles is preferably ≤30 μm, particularly preferably ≤20 μm and most preferably ≤10 μm, and/or preferably ≥1 μm, particularly preferably ≥2 μm and most preferably ≥3 μm.

The particle size distribution of the core-shell composite particles is preferably monomodal but can also be bimodal or polymodal and is preferably narrow. The volume-weighted particle size distribution of the core-shell composite particles is characterized by a value for (d₉₀−d₁₀)/d₅₀ (width of the distribution) of preferably ≤2.5, particularly preferably ≤2 and most preferably ≤1. The value of (d₉₀ −d₁₀)/d₅₀ is preferably ≥0.4, particularly preferably ≥0.6 and most preferably ≥0.8.

The shell or the core-shell composite particles is/are characterized by BET surface areas of preferably ≤50 m²/g, particularly preferably ≤25 m²/g and most preferably ≤10 m²/g (determination in accordance with DIN 66131 (using nitrogen)).

The core-shell composite particles have sphericities of preferably 0.3≤ψ≤1, particularly preferably 0.7≤ψ≤0.99 and most preferably 0.8≤ψ≤0.98.

The shell has a layer thickness, in particular an average layer thickness, of preferably from 1 to 100 nm, particularly preferably from 3 to 50 nm and most preferably from 5 to 20 nm.

The shell has a layer thickness of preferably from 1 to 100 nm, particularly preferably from 3 to 50 nm and most preferably from 5 to 20 nm at at least one position on the core-shell composite, particles (method of determination: HR-TEM).

The core of a core-shell composite particle preferably contains ≥100, particularly preferably ≥300 and most preferably ≥500 silicon particles (method of determination: SEM), in particular with average particle sizes d₅₀ according to the invention.

The silicon particles are preferably all present in the core of the core-shell composite particles.

The carbon present in the core-shell composite particles can be exclusively a carbon obtained by carbonization or carbon introduced by means of an additive. As an alternative, further components can also be present as carbon source, for example graphite, conductive carbon black, carbon naotubes (CNTs) or other carbon modifications. Preference is given to a high proportion of the carbon of the core-shell composite particles having been obtained by carbonization, for example preferably ≥40% by weight, particularly preferably ≥70% by weight and most preferably ≥90% by weight, based on the total mass of the. carbon of the core-shell composite particles.

The core-shell composite particles preferably contain from 80 to 99% by weight, more preferably from 82 to 98% by weight, particularly preferably from 85 to 97% by weight, even more preferably from. 90 to 96% by weight and most. preferably from 91 to 95% by weight, of silicon particles, based on the total weight of the core-shell composite particles. Carbon is present in the core-shell composite particles in an amount of preferably from 1 to 20% by weight, particularly preferably from 3 to 15% by weight and most preferably from 5 to 10% by weight, based on the total weight of the core-shell composite particles.

Oxygen and preferably nitrogen can optionally also be present in the core-shell composite, particles; these are preferably present chemically bound in the form of heterocycles, for example, as pyridine and pyrrole units (N), furan (O) or oxazoles (N, O). The oxygen content of the core-shell composite particles is preferably ≤10% by weight, particularly preferably ≤8% by weight and most preferably ≤5% b weight. The nitrogen content of the core-shell composite particles is preferably in the range ≤1% by weight and particularly preferably from. 0.01 to 0.3% by weight. The figures in % by weight are in each case based on the total weight of the core-shell composite particles and add up in total to 100% by weight.

The present invention further provides for the use of the core-shell composite particles of the invention in electrode materials, in particular in anode materials, for lithium ion batteries, in particular for producing the negative electrodes of lithium ion batteries.

The electrode materials preferably contain one or more binders, optionally graphite, optionally one or more further electrically conductive components and optionally one or more additives, characterized in that one or more, core-shell composite particles are present.

Preferred formulations for the electrode materials, preferably contain from 50 to 95% by wedght, in particular from 60 to 85% by weight, of core-shell composite particles; from. 0 to 40% by weight, in particular from 0 to 20% by weight, of further electrically conductive components; from 0 to 80% by weight, in particular from 5 to 30% by weight, of graphite; from 0 to 25% by weight, preferably from 1 to 20% by weight, particularly preferably from 5 to 15% by weight, of binders; and optionally from 0 to 80% by weight, in particular from 0.1 to 5% by weight, of additives; where the figures in % by weight are based on the total weight of the anode material and the proportions of all constituents of the anode material add up to 100% by weight.

The invention further provides lithium ion batteries comprising a cathode, an anode, a separator and an electrolyte, characterized in that the anode contains core-shell composite particles according to the invention.

In a preferred embodiment of the lithium ion batteries, the anode material of the fully charged lithium ion battery is only partially lithiated.

The present invention further provides methods for charging lithium ion batteries comprising a cathode, an anode, a separator and an electrolyte, characterized in that the anode contains core-shell composite particles according to the invention; and the anode material is only partially lithiated when the lithium ion battery is fully charged.

The invention further provides for the use of the anode materials according to the invention in lithium ion batteries which are configured in such a way that the anode materials are only partially lithiated in the fully charged state of the lithium ion batteries.

Apart from the core-shell composite particles, the customary starting materials can be used for producing the electrode materials and lithium ion batteries and the customary methods can be employed for producing the electrode materials and lithium ion batteries, for example as described in WO2015/117838 or the patent application having the application number DE 102015215415.7.

The lithium ion batteries are preferably constructed or configured and/or are preferably operated so that the material of the anode (anode material), in particular the core-shell composite particles, is only partially lithiated in the fully charged battery. The term fully charged refers to the state of the battery in which the anode material of the battery, in particular the core-shell composite particles, has its greatest lithiation. Partial lithiation of the anode material means that the maximum lithium uptake, capacity of the active material particles in the anode material, in particular the core-shell composite particles, is not exhausted.

The ratio of the lithium atoms to the silicon atoms in the anode of a lithium ion battery (Li/Si ratio) can, for example, be set via the flow of electric charge. The degree of lithiation of the anode material or of the silicon particles present in the anode material is proportional to the electric charge which has flowed. In this variant, the capacity of the anode material for lithium is not fully exhausted during charging of the lithium ion battery. This results in partial lithiation of the anode.

In an alternative, preferred variant, the Li/Si ratio of a lithium ion battery is set via the anode to cathode ratio (cell balancing). Here, the lithium ion batteries are designed so that the lithium uptake capacity of the anode, is preferably greater than the lithium release capacity of the cathode. This leads to the lithium uptake capacity of the anode not being fully exhausted, i.e. the anode material being only partially lithiated, in the fully charged battery.

In the lithium ion battery of the invention, the ratio of the lithium capacity of the anode to the lithium capacity of the cathode (anode to cathode ratio) is preferably ≥1.15, particularly preferably ≥1.2 and most preferably ≥1.3. The terms lithium capacity here preferably refers to the utilizable lithium capacity. The utilizable lithium capacity is a measure of the capability of an electrode to store lithium reversibly. The determination of the utilizable lithium capacity can, for example, be carried out by means of half cell measurements of the electrodes relative to lithium. The utilizable lithium capacity is determined in mAh. The utilizable lithium capacity corresponds to the measured delithiation capacity at a charging and discharging rate of C/2 in the voltage window from 0.8 V to 5 mV. C in C/2 refers to the specific capacity of the electrode coating.

The anode is charged with preferably ≤1500 mAh/g, particularly preferably ≤1400 mAh/g and most preferably ≤1300 mAh/g, based on the mass of the anode. The anode is preferably charged with at least. 600 mAh/g, particularly preferably ≥700 mAh/g and most preferably ≥800 mAh/g, based on the mass of the anode. These figures preferably relate to the fully charged lithium ion battery.

The degree of lithiation of silicon or the exploitation of the capacity of silicon for lithium (Si capacity utilization α) can, for example, be determined as described in the patent application having the application number DE 102015215415.7 on page 11, line 4 to page 12, line 25, in particular by means of the formula specified there for the Si capacity utilization α and the supplementary information under the headings “Determination of the delithiation capacity β” and “Determination of the proportion by weight of Si ωₛᵢ” (“incorporated by reference”).

In the partial lithiation according to the invention, the Li/Si ratio in the anode material in the fully charged state of the lithium ion battery is preferably ≤4.0, particularly preferably ≤3.5 and most preferably ≤3.1. The Li/Si ratio in the anode. Maternal in the fully charged state of the lithium ion battery is preferably ≥0.22, particularly preferably ≥0.44 and most preferably ≥0.66.

The capacity of the silicon of the anode material of the lithium ion battery is preferably utilized to an extent of ≤80%, particularly preferably ≤70% and most preferably ≤60%, based on a capacity of 4200 mAh per gram of silicon.

The core-shell composite particles of the invention display improved electrochemical behavior and lead to lithium ion batteries having high volumetric capacities and excellent use properties. The shell or the core-shell composite particles is/are permeable to lithium ions and electrons and thus make charge transport possible. Electrochemical milling is countered by the inventive structure of the core-shell composite particles. The SEI in lithium ion batteries can be greatly reduced by means of the composite particles of the invention and, due to the inventive design of the composite particles, no longer flakes off or flakes off to at least a much reduced extent. All this has a positive effect on the cycling stability of the lithium ion batteries of the invention. The advantageous effects are brought about by the configuration according to the invention of the core-shell composite particles.

A further improvement in these advantageous effects can be achieved when the batteries are operated partially charged. These features operate in a synergistic way.

The carbon basis according to the invention of the composite particles is advantageous for the conductivity of the core-shell composite particles, so that both lithium transport and electron transport to the silicon-based active material is ensured.

The core-shell composite particles of the invention are also surprisingly strong and able to withstand mechanical loads and have, in particular, a high compressive strength and a high shear strength.

The following examples serve to illustrate the, invention further:

Unless indicated otherwise, the following (comparative) examples were carried out in ambient air and under ambient pressure (1013 mbar) and at room temperature (23° C.). The following methods and materials were used in the examples:

### Spray Drying:

A spray drier having a two-fluid nozzle (Büchi drier B-290 with inert loop, nozzle 150) was used. The spray drier was rinsed with ethanol. The dispersion containing silicon particles was then introduced and dried under a nitrogen atmosphere at atmospheric pressure. The following settings were selected on the apparatus: inlet temperature 120° C., outlet temperature 50° C. to 60° C. Atomizing component in the closed circuit was nitrogen at a gas flow of 601 l/h, aspirator: 100%, pumping rate (feed rate): 30%. The dried silicon granules were precipitated by means of a cyclone.

### Carbonization:

Carbonizations were carried out using a 1200° C. three-zone tube furnace. (TFZ. 12/65/550/E301) from Carbolite GmbH using cascade regulation including a sample thermocouple type N. The temperatures reported relate to the internal temperature of the tube furnace at the position of the thermocouple. The starting material to be carbonized in each case was weighed into one or more combustion boats made of fused silica (QCS GmbH) and introduced into a working tube made of fused silica. The settings and process parameters used for the carbonizations are indicated in the respective examples.

### Classification/Sieving:

The C-coated, Si aggregates obtained after carbonization were freed of oversize particles >20 μm by wet sieving using water on stainless steel sieves on an AS 200 basic sieving machine (Retsch GmbH). The pulverulent product was dispersed in ethanol by means of ultrasound (Hielscher UIS250V; amplitude 80%, cycle: 0.75; duration: 30 minutes) (20% solids content) and applied to the sieving tower having a sieve (20 μm). Sieving was carried out with a time setting of infinity and amplitude of 50-70% with a continuous water stream flowing through. The silicon-containing suspension which exited at the bottom was filtered through a 200 nm nylon membrane and the filter residue was dried to constant mass at 100° C. and 50-80 mbar in a vacuum drying oven.

### Sphericity Determination:

The sphericity of particles was evaluated on scanning electron micrographs by means of the software package MacBiophotonics ImageJ (Abramoff, M. D., Magaihaes, P. J., Ram, S. J. “Image Processing with ImagedZ”. Biophotonics International, volume 11, issue 7, pp. 36-42, 2004).

### Porosity Determination:

The porosity of the particles was determined by means of a combination of Hg porosimetry (to determine the intraparticulate pore volume, DIN 66139) and He pycnometry (to determine the particulate solid volume, DIN 66137-2). The particulate porosity was determined by means of the ratio of hollow space volume to total volume.

### Scanning Electron Microscopy (SEM/EDX):

The microscopic studies were carried out using a Zeiss Ultra 55 scanning electromicroscope and an energy dispersive x-ray spectrometer INCA x-sight. The samples were coated with carbon by vapor deposition using a Baltec SCD500 sputtering/carbon coating instrument before examination in order to prevent charging phenomena.

### Transmission Electron Microscopy (TEM):

The analysis of the layer thickness was carried out on a Libra 120 transmission electron microscope from Zeiss. The sample preparation was carried out by embedding in a resin matrix and subsequent microtome sectioning.

### Inorganic Analysis/Elemental Analysis:

The C contents reported in the examples were determined using a Leco CS 230 analyzer, and a Leco TCH-600 analyser was used for determining O and where applicable N contents. The qualitative and quantitative determination of other elements indicated in the core-shell composite particles obtained was carried out by means of ICP (inductively coupled plasma) emission spectrometry (Optima 7300 DV, from Perkin Elmer). The samples were for this purpose digested with acid (HF/HNO₃) in a microwave (Microwave 3000, from Anton Paar). The ICP-OES determination is based on ISO 11885 “Water quality—Determination of selected elements by inductively coupled plasma atom emission spectrometry (ICP-OES) (ISO 11885:2007); German version EN ISO 11885:2009”, which is used for analyzing acidic, aqueous solutions (e.g. acidified tap water, wastewater and other water samples, aqua regia extracts of soil and sediments).

### Particle Size Determination:

The determination of the particle size distribution was carried out in accordance with ISO 13320 by means of static laser light scattering using a Horiba LA 950 and the Mie model. Here, particular care has to be taken in the preparation of the samples to ensure dispersion of the particles in the measurement solution in order not to measure the size of agglomerates instead of individual particles. In the case of the C-coated Si particles examined here, the particles were dispersed in ethanol. For this purpose, the dispersion was if necessary treated before the measurement with 250 W ultrasound for 4 minutes in a Hielscher model UIS250v laboratory ultrasound instrument with ultrasonic probe LS24d5. The average particle sizes indicated are volume averages.

### Surface Area Measurement by the BET Method:

The specific surface area of the materials was measured by gas adsorption using nitrogen on a Sorptomatic 199090 instrument (Porotec) or SA-9603MP instrument (Horiba) according to the BET method in accordance with DIN ISO 9277:2003-05.

### Si Accessibility in Respect of Liquid Media (Impermeability Test):

The determination of the accessibility of silicon in the core-shell composite particles in respect of liquid media was carried out using the following test method on materials having a known silicon content (from elemental analysis):

0.55 g of core-shell composite particles was firstly dispersed by means of ultrasound in 20 ml of a mixture of NaOH (4 M; H₂O) and ethanol (1:1 vol.) and subsequently stirred at 40° C. for 120 minutes. The particles were filtered on a 200 nm nylon membrane, washed with water to neutral pH and subsequently dried at 100° C./50-80 mbar in a drying oven. The silicon content after the NaOH treatment was determined and compared with the Si content before the test. The impermeability corresponds to the ratio of the Si content of the sample in percent after alkali treatment and the Si content in percent of the untreated core-shell composite particles.

### Determination of the Powder Conductivity:

The specific resistance of the core-shell composite particles was determined in a measurement system from Keithley, 2602 System Source Meter ID 266404, consisting of a pressure chamber (punch radius 6 mm) and a hydraulic unit (from Caver, USA, model 3851CE-9; S/N: 130306), under controlled pressure (up to 7 kN).

### EXAMPLE 1

### Core-Shell Composite Particles

### a) Production of an Si Dispersion:

A 30% strength ethanolic dispersion of silicon particles was produced by means of wet milling in a manner analogous to example 1 of DE 102015215415.7 (application number). Particle size distribution: D50: 0.80 μm, D10: 0.33 μm, D90: 1.97 μm, width (D90-D10/D50): 2.05.

### b) Spray Drying of the Si Dispersion:

171 g of a 1.4% strength aqueous solution of sodium carboxymethyl cellulose (NaCMC) were initially charged at 25° C. and diluted with 221 g of distilled water while stirring. 329 g of the Si dispersion produced in step a) were subsequently added thereto while stirring by means of a high-speed mixer. The proportion by weight of the polymer NaCMC was thus 2.5% by weight, based on the silicon proportion. The homogeneous dispersion obtained was subsequently spray dried. Scanning electron micrographs of the products of spray drying showed spherical Si granules having diameters in the range from 2 to 25 μm.

### c) Thermal Treatment of the Products of Spray Drying:

The products of spray drying from step b) were thermally treated at 250═ C. in air for 4 hours.

The Si aggregates obtained in this way were not redispersible in ethanol.

### d) Production of Core-Shell Composite Particles:

20.10 g of the Si aggregates from step c) and 2.22 g of pitch (Petromasse ZL 250M) were mixed mechanically by means of ball mills/set of rollers (Siemens/Groschopp) at 80 rpm for 3 hours. 22.44 g of the mixture obtained in this way were introduced into a fused silica boat (QCS GmbH) and carbonized in a three-zone tube furnace (TFZ 12/65/550/E301; Carbolite GmbH) using cascade regulation including a probe element type N and N₂/H₂ as inert gas: firstly heating rate 10° C./min, temperature 350° C., hold time 30 min, N₂/H₂ flow rate 200 ml/min; then directly further at heating rate 3° C./min, temperature 550° C.; then directly further at heating rate 10° C./min, temperature 1000° C., then hold time 2 hours, N₂/H₂ flow rate 200 ml/min.

After cooling, 21.45 g of a black powder were obtained (carbonization yield 96%) and this was freed of oversized particles by means of wet sieving.

11.34 g of core-shell composite particles having a particle size of D99<20 μm were obtained.

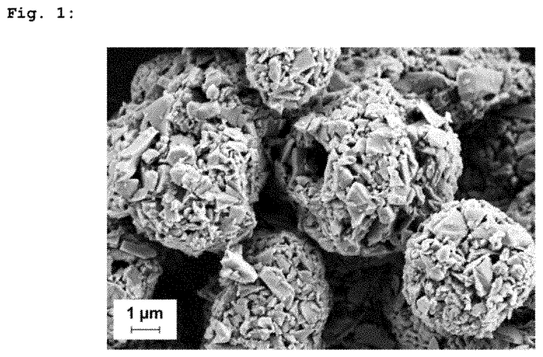

FIG. 1 shows a scanning electron micrograph of the core-shell composite particles from example 1d (7500×enlargement).

TABLE 1
Properties of the products from example (ex.) 1:

| | Unit | Ex. 1a | Ex. 1b | Ex. 1c | Ex. 1d |
|---|---|---|---|---|---|
| Porosity (core) | [% by | n.a. | n.d. | 58 | n.d. |
| | volume] | | | | |
| Aggregation of the | | No | No | Yes | Yes |
| Si particles | | | | | |
| D10 | [μm] | n.d. | n.d. | 1.37 | 4.91 |
| D50 | [μm] | 0.80 | n.d. | 4.26 | 7.66 |
| D90 | [μm] | n.d. | n.d. | 8.70 | 11.52 |
| D90 − D10/D50 | | 2.05 | n.d. | 1.72 | 0.86 |
| Modality | | monomodal | n.d. | monomodal | monomodal |
| Average sphericity | | splinter- | n.d. | 93 | 88 |
| | | like | | | |
| Impermeability | [%] | 0 | 0 | 0 | 99 |
| Powder | [μS/cm] | n.d. | n.d. | 0.15 | 275677.09 |
| conductivity | | | | | |
| BET | [m²/g] | 15.1 | 12.6 | 10.7 | 5.6 |
| C content | [% by | 0.25 | 1.19 | 0.02 | 6.39 |
| | weight] | | | | |
| O content | [% by | 1.14 | 2.52 | 3.83 | 2.21 |
| | weight] | | | | |
| H content | [% by | 0.14 | 0.29 | 0.06 | 0.02 |
| | weight] | | | | |
| N content | [% by | 0.16 | 0.05 | 0.01 | 0.12 |
| | weight] | | | | |
| Si content | [% by | | | ≥92 | ≥86 |
| | weight] | | | | |

n.d.: not determined
n.a.: not applicable

### EXAMPLE 2

Anode Comprising the Core-Shell Composite Particles from Example 1d:

7.00 q of the core-shell composite particles from example 1d were dispersed in 12.5 g of an aqueous lithium polyacrylate solution (produced from LiOH and polyacrylic acid, molecular weight 450 k, Sigma-Aldrich, Catalog No. 181285) (4% strength by weight; pH 6. 9) by means of a high-speed mixer at a circumferential velocity of 4.5 m/s for 5 minutes and after addition of 7.51 g of water for a further 15 minutes at 6 m/s with cooling at 20° C. 250 g of graphite (Imerys, KS&L) were subsequently added, whereupon the mixture was dispersed again at a circumferential velocity of 12 m/s for 30 minutes. After degassing, the dispersion was applied by means of a film drawing frame having a gap height of 0.12 mm (Erichsen, model 360) to a copper foil (Schlenk Metallfolien, SE-Cu58) having a thickness of 0.030 mm. The electrode coating produced in this way was subsequently dried for 120 minutes at 80° C. and 1 bar atmospheric pressure. The average weight per unit area of the dry anode coating was 3.11 mg/cm² and the coating thickness was 0.70 g/cm².

### EXAMPLE 3

Lithium Ion Battery Comprising the Anode from Example 2:

The electrochemical studies were carried out on a button cell type CR2032, Hohsen Corp.) in a 2-electrode arrangement. The electrode coating from example 2 was used as counterelectrode or negative electrode (Dm=15 mm). A coating based on lithium-nickel-manganese-cobalt oxide 6:2:2 having an active material content of 94.0% and an average weight per unit area of 14.82 mg/cm² was used as working electrode or positive electrode (Dm=15 mm). A glass fiber filter paper (Whatman, GF Type A/E) impregnated with 60 μl of electrolyte served as separator (Dm=16 mm). The electrolyte used consisted of a 1.0 molar solution of lithium hexafluorophosphate in a 2:8 (v/v) mixture of fluoromethyl carbonate and diethylene carbonate. The construction of the cell was carried out in a glove box (H₂O and O₂<1 ppm). The water content in the dry matter of all components used was below 20 ppm.

### Electrochemical Testing:

The electrochemical testing was carried out at 20° C. The charging of the cell was carried out by the cc/cv method (constant current/constant voltage) at a constant current of 5 mA/g (corresponds to C/25) in the first cycle and of 60 mA/g (corresponds to C/2) in the subsequent cycles and after reaching the voltage limit of 4.2 V at a constant voltage until the current went below 1.2 mA/g (corresponds to C/100) or 15 mA/g (corresponds to C/8). Discharge of the cell was carried out by the cc method (constant current) at a constant current of 5 mA/g (corresponds to C/25) in the first cycle and of 60 mA/g (corresponds to C/2) in the subsequent cycles until the voltage limit of 3.0 V was reached. The specific current selected was based on the weight of the coating of the positive electrode.

On the basis of the formulation in examples 2 and 3, the lithium ion battery was operated with partial lithiation by cell balancing. The results of the electrochemical testing are summarized in table 2.

### COMPARATIVE EXAMPLE 4

Anode Comprising the Silicon Particles from Example 1a:

11.0 g of the diluted, ethanolic Si dispersion (21.8% strength by weight) from example 1a were dispersed in 12.52 g of a 1.4% strength by weight solution of sodium carboxymethyl cellulose (Daicel, Grade 1380), in water by means of a high-speed mixer at a circumferential velocity of 4.5 m/s for 5 minutes and of 17 m/s for 80 minutes with cooling at 20° C. After addition of 0.856 q of graphite (Imerys, KS6L C), the mixture was then stirred for a further 30 minutes at a circumferential velocity of 12 m/s. After degassing, the dispersion was applied by means of a film drawing frame having a gap height of 0.20 mm (Erichsen, model 360) to a copper foil having a thickness of 0.030 mm (Schlenk Metallfolien, SE-Cu58). The anode coating produced in this way was subsequently dried for 60 minutes at 80° C. and 1 bar atmospheric pressure. The average weight per unit area of dry anode coating was 2.90 mg/cm² and the coating density was 0.96 g/cm3.

### COMPARATIVE EXAMPLE 5

Lithium ion Battery Comprising the Anode from Comparative Example, 4

The electrochemical studies were carried out on a button cell (type CR2032, Hohsen Corp.) in a 2-electrode arrangement. The electrode coating from comparative example 4 was used as counterelectrode or negative electrode (Dm=15 mm), and a coating based on lithium-nickel-manganese-cobalt oxide 1:1:1 having a content of 94.0% and an average weight per unit area of 14.5 mg/cm² was used as working electrode or positive electrode (Dm=15 mm). A glass fiber filter paper (Whatman, GD Type D) impregnated with 120 μl of electrolyte served as separator (Dm=16 mm). The electrolyte used consisted of a 1.0 molar solution of lithium hexafluorophosphate in a 3:7 (v/v) mixture of fluoroethylene carbonate and ethyl methyl carbonate which had been admixed with 2.0% by weight of vinylene carbonate. The construction of the cell was carried out in a glove box (<1 ppm H₂O, O₂), and the water content in the dry matter of all components used was below 20 ppm.

On the basis of the formulation in the comparative examples 4 and 5, the lithium ion battery was operated with partial lithiation by cell balancing.

The electrochemical testing was carried out in a manner identical to that described for example 3. The results of the electrochemical testing are summarized in table 2.

TABLE 2
Results of the electrochemical testing of the
(comparative) examples 3 and 5:

| | | Number of cycles |
|---|---|---|
| | Discharge capacity | with ≥80% |
| | after cycle 1 | capacity |
| (C) Ex. | [mAh/cm²] | retention |
| 3 | 2.03 | 103 |
| 5 | 1.99 | 60 |

1. A core-shell composite particle, comprising:
a shell based on carbon and is nonporous, and
a core, the core is a porous aggregate containing a plurality of silicon particles and carbon, wherein the silicon particles have average particle sizes d₅₀ of from 0.5 to 5 μm and are present in the core in a proportion of ≥80% by weight, based on the total weight of the core-shell composite particle, and the core-shell composite particle contains from 91 to 99% by weight of silicon particles, based on the total weight of the core-shell composite particle, with the proviso that the core-shell composite particle docs not contain any graphite.

2. The core-shell composite particle of claim 1, wherein the shell of the core-shell composite particle is obtainable by carbonization of one or more carbon precursors selected from the group consisting of tars, pitches, polyacrylonitrile and hydrocarbons having from 1 to 20 carbon atoms.

3. The core-shell composite particle of claim 1, wherein the core of the core-shell composite particle has a porosity of from 30 to 75%.

4. The core-shell composite particle of claim 1, wherein the shell has a porosity of ≤2%.

5. The core-shell composite particle of claim 1, wherein the pores of the shell are <10 nm.

6. The core-shell composite particle of claim 1, wherein the core-shell composite particle includes from 91 to 98% by weight of silicon particles, based on the total weight of the core-shcll composite particle.

7. The core-shell composite particle of claims 1, wherein the core-shell composite particle includes from 1 to 10% by weight of carbon, based on the total weight of the core-shell composite particle.

8. A method for producing the core-shell composite particles of claim 1, wherein
1) drying dispersions containing silicon particles having average particle sizes d₅₀ of from 0.5 to 5 μm, one or more organic binders and one or more dispersion media,
2) optionally thermally treating the products of drying from step 1), and
3) carbonizing one or more carbon precursors one the products of drying from step 1) or on the thermally treated products of drying from step 2).

9. The method for producing the core-shell composite particles of claim 8, wherein the one or more organic binders are selected front the group consisting of resorcinol-formaldehyde resin, phenol-formaldehyde resin, lignin, carbohydrates, polyamides, polyimides, polyethers, polyvinyl alcohols, homopolymers and copolymers of vinyl esters, homopolymers and copolymers of (meth)acrylic acid, polyacrylonitriles and polyvinylpyrrolidones.

10. The core-shell composite particles of claim 1, wherein the core-shell composite particles form anode materials for lithium ion batteries.

11. A lithium ion battery comprising:
a cathode,
an anode,
a separator, and
an electrolyte, wherein the anode is based on an anode material including one or more core-shell composite particles of claims 1.

12. The lithium ion battery of claim 11, wherein the anode material is only partially lithiated in a fully charged lithium ion battery.

13. The lithium ion battery of claim 12, wherein the anode in the fully charged lithium ion battery is charged with from 600 to 1500 mAh, g, based on the mass of the anode.

14. The lithium ion battery of claim 12, wherein the ratio of lithium atoms to silicon atoms in the anode material is ≤2.2 in the fully charged state of the lithium ion battery.

15. The lithium ion battery of claim 12, wherein the capacity of the silicon of the anode material of the lithium ion battery is utilized to an extent of ≤50%, based on the maximum capacity of 4200 mAh per gram of silicon.
